(19) United States
(12) Patent Application Publication
(10) Pub. No.: US 2005/0112488 A1
(43) Pub. Date: May 26, 2005

(54) Toner and developer, and image forming method and apparatus using the developer

(76) Inventors: Hiroshi Yamada, Numazu-shi (JP); Masami Tomita, Numazu-shi (JP); Toshiki Nanya, Mishima-shi (JP); Fumuhiro Sasaki, Fuji-shi (JP); Shigeru Emoto, Numazu-shi (JP); Naohito Shimota, Suntou-gun (JP); Shinichiro Yagi, Numazu-shi (JP); Hiroto Higuchi, Numazu-shi (JP); Tomomi Suzuki, Numazu-shi (JP); Junichi Awamura, Suntou-gun (JP); Takahiro Honda, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/960,084

(22) Filed: Oct. 8, 2004

(30) Foreign Application Priority Data
Oct. 8, 2003 (JP) 2003-349060
Nov. 28, 2003 (JP) 2003-400263

(51) Int. Cl. G03G 9/08

(52) U.S. Cl. 430/108.7; 430/110.3; 430/109.4

(57) ABSTRACT

A toner is provided that contains a particulate toner material (mother toner) having an average circularity of from 0.93 to 0.99, and including a modified polyester resin and a colorant; and an external additive in an amount of from 0.3 to 5.0 parts by weight per 100 parts by weight of the mother toner, wherein the toner has a melting viscosity of from 70 to 140 Pa·s at 160° C., a weight-average particle diameter of from 3 to 7 μm, a ratio thereof to a number-average particle diameter of from 1.91 to 1.25, wherein particles satisfy at least one of (I) and (II): (I) particles having a diameter of 4 μm or less in an amount less than 10% by number; or (II) particles having a diameter of 8 μm or more in an amount less than 2% by volume, along with a one or two component developer containing the toner, a cartridge containing the toner, an image forming method using the toner and an image forming apparatus using the toner.

### BACKGROUND OF THE INVENTION

1. Field of the Invention

The present invention relates to a toner, particularly for use in a developer for developing an electrostatic latent image by electrophotography, electrostatic recording, electrostatic printing and the like, and to an electrophotographic image forming method and an image forming apparatus using the toner.

2. Discussion of the Background

In electrostatic latent image formation in the methods of electrophotography, electrostatic recording, electrostatic printing and the like, a developer is adhered to an image bearer, such as a photoreceptor on which an electrostatic latent image is formed in the development process. The developer is then transferred therefrom onto a transfer medium, such as a transfer paper, in a transfer process; and then fixed on the transfer medium in a fixing process. The developer can be generally a two-component developer formed of a carrier and a toner; or a one-component developer without a carrier, i.e., a magnetic or a non-magnetic toner, respectively.

Conventionally, a dry toner is formed by kneading a toner binder, such as a styrene resin or a polyester resin, with a colorant upon application of heat to form a kneaded mixture, cooling the mixture to solidify the mixture and pulverizing the solidified mixture.

The particle diameter of the toner is downsized to produce high-definition and high-quality images. However, a toner formed by the conventional kneading and pulverizing method has an amorphous particle form and cannot be classified. This is because ultrafine particles having a strong adherence keep adhering to the toner having a desired particle diameter, even after a classifying process. In an image forming apparatus, such ultrafine particles adhere to a carrier and apparatus parts and are fixed thereon due to being stirred with the carrier in the image developer, and due to contact stress from a developing roller, a toner feeding roller, a layer-thickness regulation blade and/or a frictional-charged blade. In the meantime, fluidizer is buried in the surface of the toner, resulting in deterioration of the quality of the resultant images. In addition, amorphous toner having low fluidity as a powder needs a large amount of fluidizer and the filling rate thereof into a toner bottle is so low that the amorphous toner is one of the impediments to downsizing of the apparatus. Therefore, toners having a small particle diameter are not yet fully utilized. Further, the kneading and pulverizing method has a particle diameter limit, and is unable to further effectively downsize the particle diameter beyond that limit.

Further, to stabilize various properties of the toner, such as the chargeability thereof, a method of sharpening the particle diameter distribution is used. However, the method does not work well when the average particle diameter of the toner and the peak of the specific particle diameter distribution match each other. Namely, the average particle diameter is an average, and does not show a content of the toner having too small or large a particle diameter. In addition, a generalized and specified relationship therebetween is insufficient and the toner preferably has a specific particle diameter distribution and a specific shape.

Further, to produce full-color images, the transfer process for transferring an image formed of multiple color toners from a photoreceptor to a transfer medium and a paper is complicated. Because of its poor transferability, amorphous pulverized toner is consumed in a larger amount to achieve the same level of image formation.

However, a spherical toner cannot be readily removed with a cleaner (for removing residual toner from the photoreceptor and transfer medium), such as a cleaning blade or a cleaning brush, thus causing defective cleaning. In addition, the whole surface of the spherical toner is exposed outside and the spherical toner easily contacts the carrier and a charged member such as a charged blade. Therefore, an external additive and a charge controlling agent present on the surface of the toner are easily buried therein, resulting in deterioration of the fluidity of the toner.

Accordingly, demands for reducing the running costs and producing high-definition images, without image omission, by improving transferability of the toner to decrease the consumption thereof, are increasing. This is because better transferability of the toner can dispense with the need for a cleaning unit to remove untransferred toner from a photoreceptor and a transfer medium. Therefore the apparatus can be downsized, the cost can be reduced and there is minimal waste toner. To improve such disadvantages due to the shapes, methods of producing toners having various shapes have been proposed. A method of producing a toner by suspension polymerization can only produce a spherical or almost spherical toner, and an ultrafine powder tends to be produced because an irregular shearing stress is applied to toner materials in a suspension dispersion in water. Therefore the resultant toner still has poor cleanability and adheres to the carrier and parts of the apparatus. On the other hand, a method of producing a toner by emulsion polymerization can produce both an amorphous and a spherical toner. However, a shape of the toner after the polymerization needs to be controlled upon application of heat, and an ultrafine powder which has not agglutinated in water tends to remain. Therefore the resultant toner still has poor cleanability and adheres to the carrier and parts of the apparatus. Further, each of the toners produced by the above methods is not previously designed in consideration of its suitability to an external additive.

Japanese Laid-Open Patent Publication No. 7-152202 discloses a polymer dissolution suspension method accompanied with a volume contraction.

The method includes dispersing or dissolving toner materials in a volatile solvent, such as a low-boiling organic solvent, to form a dispersion or a solution; emulsifying the dispersion or solution in a water medium including a dispersant, to be a droplet; and removing the volatile solvent therefrom. Then, the volume of the droplet contracts, and only amorphous particles are formed, when a solid particulate dispersant which is not dissolved in the water medium is used as the dispersant.

When the solid content is increased to improve productivity, the viscosity of the dispersed phase increases, and the resultant particles have a large particle diameter and a broad particle size distribution. When the viscosity is decreased by using a low-molecular-weight resin, fixability, and particularly hot offset resistance, of the resultant toner deteriorates.

Japanese Laid-Open Patent Publication No. 11-149179 discloses a method of decreasing the viscosity of the dispersed phase using a low-molecular-weight resin in the polymer dissolution suspension method to make the emulsification easier, and performing an inter-particle polymerization to improve the fixability of the resultant toner. However, this does not improve the transferability and cleanability thereof by controlling the shape thereof.

In addition, an ultrafine powder tends to be produced because an irregular shearing stress is applied to toner materials in the suspension/dispersion in water, and therefore the resultant toner still has poor cleanability and adheres to the carrier and parts of the apparatus.

After transfer, these dry toners are fixed on a transfer medium, such as a paper, upon application of heat with a heating roller. When the heating roller has too high temperature, the toner is excessively melted and fusion-bonded thereon (hot offset). When the temperature is too low, the toner is not fully melted and not sufficiently fixed thereon.

In terms of saving energy and downsizing the apparatus, a toner having both a hot offset resistance and a low-temperature fixability is required. Further, the toner is required to have a thermostable preservability so as not to be blocked at atmospheric temperature in the apparatus. Particularly, a toner for use in full-color copiers and printers is required to have glossiness and color mixability. Therefore the toner needs to have a lower melting viscosity and a sharp melting polyester toner binder is used therein. However, such a toner has poor hot offset resistance. Therefore a silicone oil is typically applied to the heating roller of the full-color apparatus.

However, the method of applying the silicone oil to the heating roller needs an oil tank and an oil applicator, which complicate and enlarge the apparatus. In addition, the heating roller deteriorates and needs periodic maintenance. Further, the oil inevitably adheres to copy papers and OHP films, and particularly the oil impairs color tone of the OHP films.

Because of these reasons, a need exists for a toner having a small particle diameter and good fluidity, developability and transferability, and producing high-quality images without filming for long periods, and having a long life.

### SUMMARY OF THE INVENTION

Accordingly, one object of the present invention is to provide a toner having a small particle diameter and good fluidity, developability and transferability, and producing high-quality images without filming for long periods, and having a long life.

Another object of the present invention is to provide a toner container filled with the toner.

A further object of the present invention is to provide a developer including the toner.

Another object of the present invention is to provide an image forming method using the developer.

A further object of the present invention is to provide an image forming apparatus using the developer.

These objects and other objects of the present invention, either individually or collectively, have been satisfied by the discovery of a toner comprising a particulate toner material having an average circularity of from 0.93 to 0.99, and an external additive;
wherein the particulate toner material comprises a modified polyester binder resin, and a colorant,
wherein the toner has a melting viscosity of from 70 to 140 Pa·s at 160° C., a weight-average particle diameter (D4) of from 3 to 7 μm, a ratio (D4/Dn) of the weight-average particle diameter to a number-average particle diameter (Dn) of the toner of from 1.01 to 1.25, wherein the particles satisfy at least one of the following conditions (I) and (II): (I) particles having a particle diameter not greater than 4 μm are present in an amount less than 10% by number; or (II) particles having a particle diameter not less than 8 μm are present in an amount less than 2% by volume, and wherein the toner includes the external additive in an amount of from 0.3 to 5.0 parts by weight per 100 parts by weight of the particulate toner material.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIGS. 1A to 1D are schematic views illustrating embodiments of photosensitive layer compositions of the amorphous silicone photoreceptor for use in the present invention;

FIG. 2 is a schematic view illustrating an embodiment of the image forming apparatus of the present invention;

FIG. 3 is a schematic view illustrating another embodiment of an image forming apparatus of the present invention;

FIG. 4 is a schematic view illustrating an embodiment of the process cartridge of the present invention;

FIG. 5 is a schematic view illustrating a third embodiment of the image forming apparatus using a surf fixer of the present invention;

FIG. 6 is a schematic view partially illustrating a fourth embodiment of the present invention image forming apparatus using a charging roller as the contact charger; and

FIG. 7 is a schematic view partially illustrating a fifth embodiment of the present invention image forming apparatus using a fur or a magnetic brush as the contact charger.

### DETAILED DESCRIPTION OF THE INVENTION

The present invention provides a toner having one or more of a small particle diameter and good fluidity, developability and transferability, and producing high-quality images without filming for long periods, and having a long life, most preferably all of these characteristics.

More particularly, the present invention relates to a toner comprising a particulate toner material having an average circularity of from 0.93 to 0.99,
wherein the particulate toner material comprises a modified polyester binder resin, a colorant, and an external additive (optionally having a primary particle diameter of from 5 to 20 nm and a secondary particle diameter of from 50 to 200 nm), wherein the toner includes the external additive in an amount of from 0.3 to 5.0 parts by weight per 100 parts by weight of the particulate toner material;
wherein the toner has a melting viscosity of from 70 to 140 Pa·s at 160° C., a weight-average particle diameter (D4) of from 3 to 7 μm, a ratio (D4/Dn) of the weight-average particle diameter to a number-average particle diameter (Dn) of the toner of from 1.91 to 1.25, and
wherein the particles satisfy at least one of the following conditions (I) and (II): (I) particles having a particle diameter not greater than 4 μm are present in an amount less than 10% by number or (II) particles having a particle diameter not less than 8 μm are present in an amount less than 2% by volume.

Typically, when a modified polyester is produced in a process of dissolving or dispersing a toner composition including a prepolymer in an organic solvent to prepare a solution or a dispersion; and dispersing the solution or dispersion to form a toner, the toner has a core-shell structure. The toner is kneaded upon application of heat with a shearing force between a heating roller and a back-up roller in a fixer. Therefore, a resin forming the core and having a low softening point is exposed outside and the melted toner contaminates the inside of the fixer, resulting in contamination of the transfer paper. The toner preferably has a melting viscosity of from 70 to 140 Pa·s at 160° C. When less than 70 Pa·s, the melted toner contaminates the inside of the fixer, resulting in contamination of the transfer paper. When greater than 140 Pa·s, a cold offset problem occurs. It is difficult to solve these problems simply by controlling a thermal property of the toner, and it is necessary to repeat the melting and kneading steps of the toner in a fixer.

Typically, the smaller the toner particle diameter, the more advantageous it is for producing high-resolution and high-quality images. However, it is more disadvantageous for transferability and cleanability of the toner, and tends to produce images having insufficient image density and stripes due to the poor cleanability. In a toner having a weight-average particle diameter smaller than the range of the present invention, the toner is fusion bonded with the surface of the carrier in a two-component developer when stirred for long periods in an image developer and deteriorates the chargeability of the carrier. When used in a one-component developer, a toner film tends to form over the charging roller and the toner tends to be fusion bonded with a member, such as a blade forming a thin toner layer. Particularly, the quantitative balance of an ultrafine powder is lost, the toner tends to be more fusion bonded with the surface of the carrier, a toner film has more tendency to form over the charging roller and the toner tends to be more fusion bonded with a member, such as a blade forming a thin toner layer. The present invention toner including a modified polyester resin prevents these phenomena from occurring.

A toner having a particle diameter larger than the particle diameter range of the present invention causes difficulty in producing high-resolution and high-quality images, and at the same time, the variation in particle diameter thereof becomes large in many cases, when the toner is consumed and fed in a developer. This is same when a ratio (D4/Dn) of the weight-average particle diameter (D4) to a number-average particle diameter of the toner becomes greater than 1.25.

These problems are difficult to solve only by forming a toner having a sharp particle diameter distribution, a specific content of a fine powder and/or a specific content range of a coarse powder. Further the following specific shape range of the toner is indispensable.

Typically, when the toner has a shape close to a sphere, transferability thereof improves, but cleanability of the toner remaining on a photoreceptor after transfer becomes worse. In the present invention, the toner preferably has an average sphericity of from 0.93 to 0.99 in addition to the required particle diameter distribution. When the average sphericity is less than 0.93, the toner has low developability and produces images having low image density. When average sphericity is larger than 0.99, the toner initially has high developability and produces images having high image density, but the developability significantly deteriorates when used for long periods and the image density largely deteriorates. When the spherical toner satisfies the particle diameter requirements of the present invention, it becomes difficult to bury an external additive and a charge controlling agent in the surface of the toner particle. This is because it is supposed that a stress mechanically applied to a toner is dispersed and the stress on each particle of the toner extremely decreases even when the toner has a shape close to a sphere, provided the toner has a particle diameter distribution in a range of the present invention and a uniform particle diameter, since a toner having a large particle diameter tends to have such a phenomenon wherein an external additive and a charge controlling agent present on the surface of the toner bury therein.

Similarly, the toner preferably has a shape factor (SF-1) of from 105 to 170. When greater than 170, the toner is atomized after being stirred in an image developer for long periods, and therefore the developability deteriorates and the toner produces foggy images. Further, the transferability of the toner deteriorates and the toner produces images having low image density. When less than 105, the fluidity and chargeability of the toner changes because an external additive, such as silica, coated on the surface of the toner for the purpose of improving the fluidity thereof is buried therein. Therefore the developability deteriorates and the toner produces foggy images. Further, the cleanability of the toner remaining on a photoreceptor after transfer becomes worse.

The shape factor (SF-1) of the toner represents a degree of roundness thereof, and is determined in accordance with the following formula:
SF-1=MXLNG/AREA×π/4×100
wherein MXLNG represents an absolute maximum length of a particle and AREA represents a projected area thereof.

The toner of the present invention includes an external additive having a primary particle diameter of from 5 to 20 nm and a secondary particle diameter of from 50 to 200 nm in an amount of from 0.3 to 5.0 parts by weight per 100 parts by weight of the mother toner. When less than 0.3 parts by weight, the fluidity of the resultant toner is insufficient and transferability deteriorates. When greater than 5.0 parts by weight, the external additive is not fully adhered to the surface of the toner and some of the additive is present in its free state. In that case, the external additive alone adheres to and abrades the surface of a photoreceptor, which produces images having white spots and background fouling, and the fixability of the resultant toner deteriorates.

The external additive, preferably having a primary particle diameter of from 5 to 20 nm and a secondary particle diameter of from 50 to 200 nm, is preferably used to improve fluidity and chargeability of the resultant toner. The reason is not certain, and the present inventors do not wish to be bound by a particular mechanism of action, but it is believed that when the toner is fed in an image developer, the toner is present in a condensed state having a particle diameter of from 50 to 200 nm and stably fed therein. When stirred with a carrier in the image developer, the toner is disassembled and reaches a state of primary particles which have a suitable developability when developing. In addition, the energy generated when stirred with a carrier in the image developer is used to disassemble an aggregation of the external additive and changes of the various properties of the toner, such as deterioration of the fluidity, can be prevented. Such an external additive includes, but is not limited to, inorganic particulate materials and particulate polymer materials.

Specific preferred examples of suitable inorganic particles include silica, titanium oxide, alumina, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Specific preferred examples of suitable polymer particulate materials include polystyrene formed by a soap-free emulsifying polymerization, a suspension polymerization or a dispersing polymerization, methacrylate ester or acrylate ester copolymers, silicone resins, benzoguanamine resins, polycondensation particles such as nylon and polymer particles of thermosetting resins.

A surface treatment agent can increase the hydrophobicity of these fluidizers and prevent deterioration of fluidity and chargeability of the resultant toner even in high humidity. Any desired surface treatment agent may be used, depending on the properties of the treated particle of interest. Specific preferred examples of the surface treatment agent include silane coupling agents, silylating agents, silane coupling agents having an alkyl fluoride group, organic titanate coupling agents, aluminium coupling agents silicone oils and modified silicone oils.

Silica, titanium oxide and alumina are more preferred, and hydrophobized silica is most preferred as the external additive in the present invention.

The modified polyester resin in the present invention includes a polyester resin wherein, in addition to monomer units containing alcohol and/or acid functionality, there are monomer units present having a functional group other than acid or alcohol groups, and which can form other than an ester bond; and a polyester resin wherein plural resin components having a different structure are bonded with each other in a covalent or an electrovalent bond, etc.

For example, a polyester resin can be used having a functional group such as one or more isocyanate groups that react with an acid radical and/or a hydroxyl group at an end thereof, wherein the end is further modified or elongated with a compound including an active hydrogen atom. Further, a polyester resin having ends reacted with a compound including a plurality of hydrogen atoms can be used, such as a urea-modified polyester resin or a urethane-modified polyester resin.

In addition, a polyester resin having a reactive group, such as one or more double bonds in a main chain thereof, which is radically polymerized to have a graft component, i.e., a carbon to carbon combination or in which the double bonds are crosslinked with each other can be use, such as a styrene-modified polyester resin or an acrylic-modified polyester resin.

A polyester resin copolymerized in its main chain with a resin having a different composition, or reacted with a resin having a different composition through a carboxyl group or a hydroxyl group at an end of the polyester resin can also be used, e.g., a polyester resin copolymerized with a silicone resin having an end modified by a carboxyl group, a hydroxyl group, an epoxy group or a mercapto group, such as a silicone-modified polyester resin.

Hereinafter, the modified polyester resin will be more specifically explained.

### Synthesis Example of a Polystyrene-Modified Polyester Resin

724 parts of an adduct of bisphenol A with 2 moles of ethyleneoxide, 200 parts isophthalic acid, 70 parts of fumaric acid and 2 parts of dibutyltinoxide are mixed and reacted in a reactor vessel including a cooling pipe, a stirrer and a nitrogen inlet pipe for 8 hrs at a normal pressure and 230° C. Further, after the mixture is depressurized to 10 to 15 mm Hg (absolute) and reacted for 5 hrs, 32 parts of phthalic acid anhydride are added thereto and reacted for 2 hrs at 160° C. Next, 200 parts of styrene, 1 part of benzoyl peroxide, and 0.5 parts of dimethylaniline dissolved in ethyl acetate are reacted with the mixture for 2 hrs at 80° C., and the ethyl acetate is distilled and removed to prepare a polystyrene-graft-modified polyester resin (i) having a weight-average molecular weight of 92,000.

Urea-Modified Polyester Resin (i)

Specific examples of the urea-modified polyester resin (i) include reaction products between polyester prepolymers (A) having an isocyanate group and amines (B). The polyester prepolymer (A) is formed from a reaction between polyester having an active hydrogen atom formed by polycondensation between a polyol (1) and a polycarboxylic acid (2), and polyisocyanate (3). Specific examples of the groups including the active hydrogen include a hydroxyl group (such as an alcoholic hydroxyl group and a phenolic hydroxyl group), an amino group, a carboxyl group, a mercapto group, etc. In particular, the alcoholic hydroxyl group is preferably used.

As the polyol (1), diol (1-1) and polyols having 3 valences or more (1-2) can be used, and (1-1) alone or a mixture of (1-1) and a small amount of (1-2) are preferably used.

Specific examples of diol (1-1) include alkylene glycols such as ethylene glycol, 1,2-propylene glycol, 1,3-propylene glycol, 1,4-butanediol, and 1,6-hexanediol; alkylene ether glycols such as diethylene glycol, triethylene glycol, dipropylene glycol, polyethylene glycol, polypropylene glycol and polytetramethylene ether glycol; alicyclic diols such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide. In particular, an alkylene glycol having 2 to 12 carbon atoms and adducts of bisphenol with an alkylene oxide are preferably used, and a mixture thereof is more preferably used.

Specific examples of the polyol having 3 valences or more (1-2) include multivalent aliphatic alcohols having 3 to 8 or more valences such as glycerin, trimethylolethane, trimethylolpropane, pentaerythritol and sorbitol; phenols having 3 or more valences such as trisphenol PA, phenolnovolak, cresolnovolak; and adducts of the above-mentioned polyphenol having 3 or more valences with an alkylene oxide.

As the polycarboxylic acid (2), dicarboxylic acids (2-1) and polycarboxylic acids having 3 or more valences (2-2) can be used. (2-1) alone, or a mixture of (2-1) and a small amount of (2-2) are preferably used.

Specific examples of the dicarboxylic acid (2-1) include alkylene dicarboxylic acids such as succinic acid, adipic acid and sebacic acid; alkenylene dicarboxylic acids such as maleic acid and fumaric acid; and aromatic dicarboxylic acids such as phthalic acid, isophthalic acid, terephthalic acid and naphthalene dicarboxylic acid. In particular, an alkenylene dicarboxylic acid having 4 to 20 carbon atoms and an aromatic dicarboxylic acid having 8 to 20 carbon atoms are preferably used.

Specific examples of the polycarboxylic acid having 3 or more valences (2-2) include aromatic polycarboxylic acids having 9 to 20 carbon atoms such as trimellitic acid and pyromellitic acid.

The polycarboxylic acid (2) can be formed from a reaction between one or more of the polyols (1) and an anhydride or lower alkyl ester of one or more of the above-mentioned acids. Suitable preferred lower alkyl esters include, but are not limited to, methyl esters, ethyl esters and isopropyl esters.

The polyol (1) and polycarboxylic acid (2) are mixed such that the equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

Specific examples of the polyisocyanate (3) include aliphatic polyisocyanates such as tetramethylenediisocyanate, hexamethylenediisocyanate and 2,6-diisocyanatemethylcaproate; alicyclic polyisocyanates such as isophoronediisocyanate and cyclohexylmethanediisocyanate; aromatic diisocyanates such as tolylenedisocyanate and diphenylmethanediisocyanate; aromatic aliphatic diisocyanates such as α, α, α′, α′-tetramethylxylylenediisocyanate; isocyanurates; the above-mentioned polyisocyanates blocked with phenol derivatives, oxime and caprolactam; and their combinations.

The polyisocyanate (3) is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low-temperature fixability of the resultant toner deteriorates. When [NCO] has a molar ratio less than 1, a urea content in ester of the modified polyester decreases and hot offset resistance of the resultant toner deteriorates.

A content of the constitutional component of a polyisocyanate in the polyester prepolymer (A) having a polyisocyanate group at its end is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low-temperature fixability of the toner also deteriorate. In contrast, when the content is greater than 40% by weight, low-temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of isocyanate groups is less than 1 per molecule, the molecular weight of the modified polyester (i) decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amino groups in the amines (B1) to (B5) are blocked.

Specific examples of the diamines (B1) include aromatic diamines such as phenylene diamine, diethyltoluene diamine and 4,4′-diaminodiphenyl methane; alicyclic diamines such as 4,4′-diamino-3,3′-dimethyldicyclohexyl methane, diaminocyclohexane and isophorondiamine; aliphatic diamines such as ethylene diamine, tetramethylene diamine and hexamethylene diamine, etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan.

Specific examples of the amino acids (B5) include amino propionic acid and amino caproic acid.

Specific examples of the blocked amines (B6) include ketimine compounds which are prepared by reacting one of the amines (B1) to (B5) with a ketone such as acetone, methyl ethyl ketone and methyl isobutyl ketone; oxazoline compounds, etc. Among these amines (B), diamines (B1) and mixtures in which a diamine is mixed with a small amount of a polyamine (B2) are preferably used.

The molecular weight of the modified polyesters (i) can optionally be controlled using an elongation anticatalyst, if desired. Specific examples of the elongation anticatalyst include monoamines such as diethyl amine, dibutyl amine, butyl amine and lauryl amine, and blocked amines, i.e., ketimine compounds prepared by blocking the monoamines mentioned above.

A mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, the molecular weight of the urea-modified polyester (i) decreases, resulting in deterioration of hot offset resistance of the resultant toner. The modified polyester (i) may include a urethane bonding as well as a urea bonding. A molar ratio (urea/urethane) of the urea bonding to the urethane bonding is from 100/0 to 10/90, preferably from 80/20 to 20/80 and more preferably from 60/40 to 30/70. When the content of the urea bonding is less than 10%, hot offset resistance of the resultant toner deteriorates.

The modified polyester resin (i) of the present invention can be produced by a method such as a one-shot method. The weight-average molecular weight of the modified polyester resin (i) is not less than 10,000, preferably from 20,000 to 10,000,000 and more preferably from 30,000 to 1,000,000. When the weight-average molecular weight is less than 10,000, hot offset resistance of the resultant toner deteriorates. The number-average molecular weight of the modified polyester resin (i) is not particularly limited when the unmodified polyester resin (LL) (discussed below) is used in combination. Namely, the weight-average molecular weight of the modified polyester resin (i) has priority over the number-average molecular weight thereof. However, when the modified polyester resin (i) is used alone, the number-average molecular weight is from 2,000 to 15,000, preferably from 2,000 to 10,000 and more preferably from 2,000 to 8,000. When the number-average molecular weight is greater than 20,000, a low-temperature fixability of the resultant toner deteriorates, and in addition the glossiness of full color images deteriorates.

Unmodified Polyester Resin (LL)

In the present invention, an unmodified polyester resin (LL) can be used in combination with the modified polyester resin (i) as a toner binder resin. It is more preferable to use the unmodified polyester resin (LL) in combination with the modified polyester resin than to use the modified polyester resin alone because low-temperature fixability and glossiness of full color images of the resultant toner improve. Specific examples of the unmodified polyester resin (LL) include polycondensed products between the polyol (1) and polycarboxylic acid (2) similarly to the modified polyester resin (i), and the components preferably used are the same as those thereof. It is preferable that the modified polyester resin (i) and unmodified polyester resin (LL) are partially soluble with each other in terms of the low-temperature fixability and hot offset resistance of the resultant toner. Therefore, the modified polyester resin (i) and unmodified polyester resin (LL) preferably have similar compositions. When the unmodified polyester resin (LL) is used in combination, a weight ratio ((i)/(LL)) between the modified polyester resin (i) and unmodified polyester resin (LL) is from 5/95 to 80/20, preferably from 5/95 to 30/70, more preferably from 5/95 to 25/75, and most preferably from 7/93 to 20/80. When the modified polyester resin (i) has a weight ratio less than 5%, the resultant toner has poor hot offset resistance, and has difficulty in having a thermostable preservability and low-temperature fixability.

The unmodified polyester resin (LL) preferably has a peak molecular weight of from 1,000 to 20,000, preferably from 1,500 to 10,000, and more preferably from 2,000 to 8,000. When less than 1,000, the thermostable preservability of the resultant toner deteriorates. When greater than 10,000, the low-temperature fixability thereof deteriorates. The unmodified polyester resin (LL) preferably has a hydroxyl value not less than 5 mg KOH/g, more preferably of from 10 to 120 mg KOH/g, and most preferably from 20 to 80 mg KOH/g. When less than 5, the resultant toner has difficulty in having thermostable preservability and low-temperature fixability. The unmodified polyester resin (LL) preferably has an acid value of from 10 to 30 mg KOH/g such that the resultant toner tends to be negatively charged and to have better fixability. When greater than 30 mg KOH/g, chargeability of the resultant toner deteriorates, particularly when used in an environment of high humidity and high temperature, and produces images having background fouling.

In the present invention, the unmodified polyester resin (LL) preferably has a glass transition temperature (Tg) of from 35 to 55° C., and more preferably from 40 to 55° C. The resultant toner can have thermostable preservability and low-temperature fixability. A dry toner of the present invention including the unmodified polyester resin (LL) and the modified polyester resin (i) has a better thermostable preservability than known polyester toners even though the glass transition temperature is low.

In the present invention, the toner binder resin preferably has a temperature at which a storage modulus of the toner binder resin is 10,000 dyne/cm² at a measuring frequency of 20 Hz (TG′), of not less than 100° C., and more preferably of from 110 to 200° C. When less than 100° C., the hot offset resistance of the resultant toner deteriorates. The toner binder resin preferably has a temperature at which the viscosity is 1,000 poise (Tη), of not greater than 180° C., and more preferably of from 90 to 160° C. When greater than 180° C., the low-temperature fixability of the resultant toner deteriorates. Namely, TG′ is preferably higher than Tη in terms of the low-temperature fixability and hot offset resistance of the resultant toner. In other words, the difference between TG′ and Tη (TG′-Tη) is preferably not less than 0° C., more preferably not less than 10° C., and furthermore preferably not less than 20° C. The maximum of the difference is not particularly limited. In terms of the thermostable preservability and low-temperature fixability of the resultant toner, the difference between TG′ and Tη (TG′-Tη) is preferably from 0 to 100° C., more preferably from 10 to 90° C., and most preferably from 20 to 80° C.

Specific examples of the colorants for use in the present invention include any known dyes and pigments such as carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1 to 15% by weight, and more preferably from 3 to 10% by weight, based on total weight of the toner.

The colorant for use in the present invention can be used as a master batch pigment, if desired, when combined with a resin.

Specific examples of the resin for use in the master batch pigment or for use in combination with master batch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The master batch for use in the toner of the present invention is typically prepared by mixing and kneading a resin and a colorant upon application of high shear stress thereto. In this case, an organic solvent can be used to heighten the interaction of the colorant with the resin. In addition, flushing methods in which an aqueous paste including a colorant is mixed with a resin solution of an organic solvent to transfer the colorant to the resin solution and then the aqueous liquid and organic solvent are separated and removed, can be preferably used because the resultant wet cake of the colorant can be used as it is. Of course, a dry powder which is prepared by drying the wet cake can also be used as a colorant. In this case, a three roll mill is preferably used for kneading the mixture upon application of high shearing stress.

The toner of the present invention may include a wax together with a binder resin and a colorant. The presence of the wax in a toner largely affects releasability thereof when fixed, and when the wax is finely dispersed in a toner and present close to the surface thereof in a large amount, the toner has good releasability. Particularly, the wax is preferably dispersed with a major axis not greater than 1 μm. When the wax is present on the surface of the toner in a large amount, the wax is easily released therefrom when stirred for long periods in an image developer and adhered to the surface of a carrier and a member of the image developer, resulting in deterioration of chargeability of a developer including the toner.

The dispersion status of the wax is observed with an amplified picture taken through a transmission electron microscope.

Specific examples of the wax include known waxes, e.g., polyolefin waxes such as polyethylene wax and polypropylene wax; long chain carbon hydrides such as paraffin wax and sasol wax; and waxes including carbonyl groups. Among these waxes, the waxes including carbonyl groups are preferably used. Specific examples thereof include polyesteralkanates such as camauba wax, montan wax, trimethylolpropanetribehenate, pentaelislitholtetrabehenate, pentaelislitholdiacetatedibehenate, glycerinetribehenate and 1,18-octadecanedioldistearate; polyalkanolesters such as tristearyltrimellitate and distearylmaleate; polyamidealkanates such as ethylenediaminebehenylamide; polyalkylamides such as tristearylamidetrimellitate; and dialkylketones such as distearylketone. Among these waxes including a carbonyl group, a polyesteralkanate is preferably used.

The wax for use in the present invention usually has a melting point of from 40 to 160° C., preferably of from 50 to 120° C., and more preferably of from 60 to 90° C. A wax having a melting point less than 40° C. has an adverse effect on its high temperature preservability, and a wax having a melting point greater than 160° C. tends to cause cold offset of the resultant toner when fixed at a low temperature. In addition, the wax preferably has a melting viscosity of from 5 to 1,000 cps, and more preferably of from 10 to 100 cps when measured at a temperature higher than the melting point by 20° C. A wax having a melting viscosity greater than 1,000 cps makes it difficult to improve hot offset resistance and low temperature fixability of the resultant toner. The content of the wax in a toner is preferably from 0 to 40% by weight, and more preferably from 3 to 30% by weight.

The toner of the present invention may optionally include a charge controlling agent. The charge controlling agent fixed on the toner surface can improve chargeability of the toner.

When the charge controlling agent is fixed on the toner surface, a presence amount and status thereof can be stabilized, and therefore the chargeability of the toner can be stabilized. Particularly, the toner of the present invention has better chargeability when including the charge controlling agent.

Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc.

Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity, and thereby the electrostatic force of a developing roller attracting the toner increases, resulting in deterioration of the fluidity of the toner and image density of the toner images.

The charge controlling agent and release agent can be kneaded upon application of heat together with a master batch pigment and a resin, or can be added to toner constituents when dissolved and dispersed in an organic solvent.

The toner of the present invention may also include a cleanability improver for removing a developer remaining on a photoreceptor and a first transfer medium after transfer. Specific examples of the cleanability improver include fatty acid metallic salts such as zinc stearate, calcium stearate and stearic acid; and polymer particles prepared by a soap-free emulsifying polymerization method such as polymethylmethacrylate particles and polystyrene particles. The polymer particles have a comparatively narrow particle diameter distribution and preferably have a volume-average particle diameter of from 0.01 to 1 μm.

The toner binder of the present invention can be prepared, for example, by the following method. Polyol (1) and polycarboxylic acid (2) are heated at a temperature of from 150 to 280 □ in the presence of a known catalyst, such as tetrabutoxy titanate and dibutyltinoxide. The water generated is removed, under a reduced pressure if desired, to prepare a polyester resin having a hydroxyl group. The polyester resin is then reacted with polyisocyanate (3) at a temperature of from 40 to 140° C. to prepare a prepolymer (A) having an isocyanate group. Further, the prepolymer (A) is reacted with an amine (B) at a temperature of from 0 to 140° C., to prepare a modified polyester resin (i). When polyisocyanate, and A and B are reacted, a solvent can be used if desired. Suitable solvents include solvents which do not react with polyisocyanate (3). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran.

When polyester (LL), which does not have a urea bond, is used in combination with the urea-modified polyester, a method similar to a method for preparing a polyester resin having a hydroxyl group is used to prepare the polyester resin (LL), and the polyester (LL) is dissolved and mixed in a solution after a reaction of the modified polyester (i) is completed.

A dry toner can be produced by the following method, but the method is not limited thereto.

Toner constituents such as a toner binder resin including the modified polyester resin (i), a charge controlling agent and a pigment are mechanically mixed. This mixing process can be performed with an ordinary mixer such as rotating blades under ordinary conditions, and is not particularly limited.

After the mixing process is completed, the mixture is kneaded upon application of heat by a kneader. The kneader includes axial and biaxial continuous kneaders, and roll-mill batch type kneaders. It is essential to see that the kneading upon application of heat does not cut a molecular chain of the toner binder resin. Specifically, the kneading temperature depends on a softening point of the toner binder resin. When too much below the softening point, cutting of the molecular chain of the toner binder resin increases. When too high above the softening point, the toner binder resin is not well dispersed.

After the kneading process is completed, the kneaded mixture is pulverized. The mixture is preferably crushed first, and next pulverized. Methods of crashing the mixture into a collision board and pulverizing the mixture in a narrow gap between a rotor and a stator mechanically rotated are preferably used.

After the pulverizing process is completed, the pulverized mixture is classified in an airstream by centrifugal force to prepare a toner having a predetermined particle diameter, e.g., an average particle diameter of from 5 to 20 μm.

In addition, to improve the fluidity, preservability, developability and transferability of the toner, inorganic fine particles, such as a hydrophobic silica fine powder as mentioned above, are externally added to the toner. A conventional powder mixer can be used to mix the external additive, and the mixer preferably has a jacket and can control an inner temperature thereof. To change a history of a load to the external additive, the external additive may be added to the toner completely prior to mixing or gradually added thereto during mixing. As a matter of course, the number of revolutions, rolling speed, time and temperature of the mixer may be changed. A large load first and next a small load, or vice versa may be applied to the toner.

Specific examples of the mixer include a V-form mixer, a locking mixer, a Loedge Mixer, a Nauter Mixer, a Henshel Mixer, etc.

To ensphere the toner, a method of mechanically ensphering the toner by using a hybridizer or a Mechanofusion after the pulverizing process, a method which is so-called a spray dry method of ensphering the toner by using a spray dryer to remove a solvent after toner materials are dissolved and dispersed in the solvent capable of dissolving a toner binder, and a method of ensphering the toner by heating the toner in an aqueous medium can be used. However, the methods are not limited thereto.

The toner of the present invention is preferably prepared by the following method.

First, an oil dispersion wherein a polyester prepolymer including an isocyanate group A is dissolved in an organic solvent, a colorant is dispersed and a release agent is dissolved or dispersed is prepared.

The oil dispersion is pulverized by a wet pulverizer to pulverize and uniformly disperse the colorant therein for 30 to 120 min.

Next, the oil dispersion is emulsified in the presence of an inorganic particulate material and/or a particulate polymer material to form an oil-in-water emulsion and a urea-modified polyester resin C produced by a reaction between the polyester prepolymer including an isocyanate group A and an amine B.

Specific examples of the organic solvent include organic solvents dissolving polyester resins, and which is insoluble, hardly soluble or slightly soluble in water. The organic solvent preferably has a boiling point of from 60 to 150° C., and more preferably from 70 to 120° C. Specific examples of such an organic solvent include ethyl acetate, methyl ethyl ketone, etc.

A solid particulate dispersant in the aqueous phase uniformly disperses oilspots therein. The solid particulate dispersant is located on a surface of the oilspot, and the oilspots are uniformly dispersed and assimilation among the oilspots is prevented. Therefore, the resultant toner has a sharp particle diameter distribution.

The solid particulate dispersant is preferably an inorganic particulate material having an average particle diameter of from 0.01 to 1 μm, which is difficult to dissolve in water and is solid in the aqueous medium.

Specific examples of the inorganic particulate material include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Further, tricalcium phosphate, calcium carbonate, colloidal titanium oxide, colloidal silica and hydroxyapatite are preferably used. Particularly, hydroxyapatite which is a basic reaction product between sodium phosphate and calcium chloride is more preferably used.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid. When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C. When the temperature is relatively high, the modified polyester (i) or prepolymer (A) can easily be dispersed because the dispersion formed thereof has a low viscosity.

The content of the aqueous medium to 100 parts by weight of the toner constituents including the modified polyester (i) or prepolymer (A) is typically from 50 to 2,000 parts by weight, and preferably from 100 to 1,000 parts by weight. When the content is less than 50 parts by weight, the dispersion of the toner constituents in the aqueous medium is not satisfactory, and thereby the resultant mother toner particles do not have the desired particle diameter. In contrast, when the content is greater than 2,000, the production cost increases. A dispersant can preferably be used to prepare a stably dispersed dispersion including particles having a sharp particle diameter distribution.

Specific preferred examples of the dispersants used to emulsify and disperse an oil phase in an aqueous liquid in which the toner constituents are dispersed, include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)—N-ethylsulfonyl glycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

In addition, inorganic compound dispersants such as tricalcium phosphate, calcium carbonate, titanium oxide, colloidal silica and hydroxyapatite, which are hardly soluble in water, can also be used.

Further, it is possible to stably disperse toner constituents in water using a polymeric protection colloid. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, β-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyalkylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

When an acid such as calcium phosphate or a material soluble in alkaline is used as a dispersant, the calcium phosphate is dissolved with an acid such as a hydrochloric acid and washed with water to remove the calcium phosphate from the toner particle. Besides this method, it can also be removed by an enzymatic hydrolysis.

When a dispersant is used, the dispersant may remain on a surface of the toner particle. However, the dispersant is preferably washed and removed after the elongation and/or crosslinking reaction of the prepolymer with amine.

Further, to decrease viscosity of a dispersion medium including the toner constituents, a solvent which can dissolve the modified polyester (i) or prepolymer (A) can be used because the resultant particles have a sharp particle diameter distribution. The solvent is preferably volatile and has a boiling point lower than 100° C., from the viewpoint of being easily removed from the dispersion after the particles are formed. Specific examples of such a solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used.

The addition quantity of such a solvent is from 0 to 300 parts by weight, preferably from 0 to 100, and more preferably from 25 to 70 parts by weight, per 100 parts by weight of the prepolymer (A) used. When such a solvent is used to prepare a particle dispersion, the solvent is removed therefrom under a normal or reduced pressure after the particles are subjected to an elongation reaction and/or a crosslinking reaction of the prepolymer with amine.

The elongation and/or crosslinking reaction time depend on reactivity of the isocyanate structure of the prepolymer (A) and amine (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

To remove an organic solvent from the emulsified dispersion, a method of gradually raising the temperature of the whole dispersion to completely remove the organic solvent in the droplet by vaporizing can be used. Otherwise, a method of spraying the emulsified dispersion in dry air, completely removing a water-insoluble organic solvent from the droplet to form toner particles and removing the water dispersant by vaporizing can also be used. As the dry air, atmospheric air, nitrogen gas, carbon dioxide gas, a gaseous body in which a combustion gas is heated, and particularly various aerial currents heated to have a temperature not less than a boiling point of the solvent used are typically used. A spray dryer, a belt dryer and a rotary kiln can sufficiently remove the organic solvent in a short time.

When the emulsified dispersion is washed and dried while maintaining a wide particle diameter distribution thereof, the dispersion can be classified to have a desired particle diameter distribution.

A cyclone, a decanter, a centrifugal separation, etc. can remove particles in a dispersion liquid. The powder remaining after the dispersion liquid is dried can be classified, but the liquid is preferably classified in terms of efficiency. Unnecessary fine and coarse particles can be recycled to a kneading process to form particles. The fine and coarse particles may be wet when recycled.

Dispersant is preferably removed from the dispersion liquid, and more preferably removed at the same time when the above-mentioned classification is performed.

Heterogeneous particles such as release agent particles, charge controlling particles, fluidizing particles and colorant particles can be mixed with the toner powder after drying. Release of the heterogeneous particles from composite particles can be prevented by giving a mechanical stress to a mixed powder to fix and fuse them on a surface of the composite particles.

Specific methods include a method of applying an impact force on the mixture with a blade rotating at high-speed, a method of putting a mixture in a high-speed stream and accelerating the mixture such that particles thereof collide with each other or composite particles thereof collide with a collision board, etc. Specific examples of the apparatus include an ONG MILL from Hosokawa Micron Corp., a modified I-type mill having a lower pulverizing air pressure from Nippon Pneumatic Mfg. Co., Ltd., a hybridization system from Nara Machinery Co., Ltd., a Kryptron System from Kawasaki Heavy Industries, Ltd., an automatic mortar, etc.

The toner of the present invention can be used for a two-component developer in which the toner is mixed with a magnetic carrier. A content of the toner is preferably from 1 to 10 parts by weight per 100 parts by weight of the carrier.

Suitable carriers for use in the two component developer include, but are not limited to, known carrier materials such as iron powders, ferrite powders, magnetite powders, and magnetic resin carriers, which have a particle diameter of from about 20 to about 200 μm.

The carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

An electroconductive powder may optionally be included in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic or non-magnetic developer without a carrier.

An amorphous silicon photoreceptor (hereinafter referred to as an a-Si photoreceptor) can be used in the present invention. An a-Si photoreceptor can, for example, be formed by heating an electroconductive substrate at from 50 to 400° C. and forming an a-Si photosensitive layer on the substrate by a vacuum deposition method, a sputtering method, an ion plating method, a heat CVD method, a photo CVD method, a plasma CVD method, etc. Particularly, the plasma CVD method is preferably used, which forms an a-Si layer on the substrate by decomposing a gas material with a DC, high-frequency or microwave glow discharge.

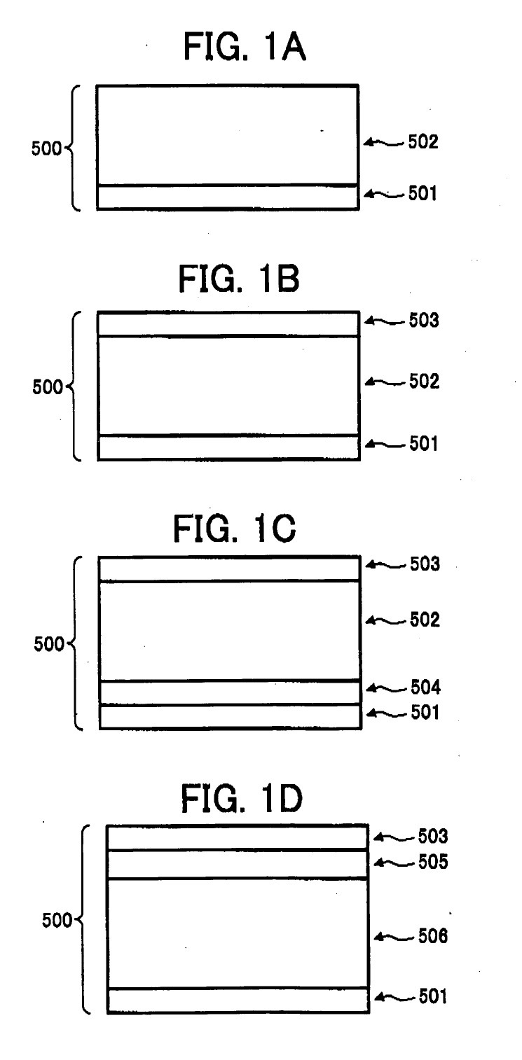

FIGS. 1A to 1D are schematic views illustrating a photosensitive layer composition of the amorphous photoreceptor for use in the present invention respectively. An electrophotographic photoreceptor 500 in FIG. 1A includes a substrate 501 and a photosensitive layer 503 thereon, which is photoconductive and formed of a-Si. An electrophotographic photoreceptor 500 in FIG. 1B includes a substrate 501, a photosensitive layer 502 thereon and an a-Si surface layer 503 on the photosensitive layer 502. An electrophotographic photoreceptor 500 in FIG. 1C includes a substrate 501, a charge injection prevention layer 504 thereon, a photosensitive layer 502 on the charge injection prevention layer 504 and an a-Si surface layer 503 on the photosensitive layer 502. An electrophotographic photoreceptor 500 in FIG. 1D includes a substrate 501, a photosensitive layer 502 thereon including a charge generation layer 505 and a charge transport layer formed of a-Si, and an a-Si surface layer 503 on the photosensitive layer 502.

The substrate of the photoreceptor may either be electroconductive or insulative. Specific examples of the substrate include metals such as Al, Cr, Mo, Au, In, Nb, Te, V, Ti, Pt, Pd and Fe and their alloyed metals such as stainless. In addition, insulative substrates such as films or sheets of synthetic resins such as polyester, polyethylene, polycarbonate, cellulose acetate, polypropylene, polyvinylchloride, polystyrene, polyamide; glasses; and ceramics can be used, provided that at least a surface of the substrate, on which a photosensitive layer is formed, is treated to be electroconductive. The substrate preferably has the shape of a cylinder, a plate or an endless belt having a smooth or a concave-convex surface. The substrate can have any desired thickness, which can be as thin as possible when an electrophotographic photoreceptor including the substrate is required to have flexibility. However, the thickness is typically not less than 10 μm in terms of production and handling conveniences, and mechanical strength of the electrophotographic photoreceptor.

The a-Si photoreceptor of the present invention may optionally include a charge injection prevention layer between the electroconductive substrate and the photosensitive layer in FIG. 3C. When the photosensitive layer is charged with a charge having a certain polarity, the charge injection prevention layer prevents a charge from being injected into the photosensitive layer from the substrate. However, the charge injection prevention layer does not prevent this when the photosensitive layer is charged with a charge having a reverse polarity, i.e., having a dependency on the polarity. The charge injection prevention layer includes more atoms controlling conductivity than the photosensitive layer to have such a capability.

The charge injection prevention layer preferably has a thickness of from 0.1 to 5 μm, more preferably from 0.3 to 4 μm, and most preferably from 0.5 to 3 μm in terms of desired electrophotographic properties and economic effects.

The photosensitive layer 502 is formed on an undercoat layer optionally formed on the substrate 501 and has a thickness as desired, and preferably of from 1 to 100 μm, more preferably from 20 to 50 μm, and most preferably from 23 to 45 μm in terms of desired electrophotographic properties and economic effects.

The charge transport layer is a layer transporting a charge when the photosensitive layer is functionally separated. The charge transport layer includes at least a silicon atom, a carbon atom and a fluorine atom, and optionally includes a hydrogen atom and an oxygen atom. Further, the charge transport layer has photosensitivity, charge retainability, charge generation capability and charge transportability as desired. In the present invention, the charge transport layer preferably includes an oxygen atom.

The charge transport layer has a thickness as desired in terms of electrophotographic properties and economic effects, preferably of from 5 to 50 μm, more preferably from 10 to 40 μm, and most preferably from 20 to 30 μm.

The charge generation layer is a layer generating a charge when the photosensitive layer is functionally separated. The charge generation layer includes at least a silicon atom, does not substantially include a carbon atom and optionally includes a hydrogen atom. Further, the charge generation layer has photosensitivity, charge generation capability and charge transportability as desired.

The charge generation layer has a thickness as desired in terms of electrophotographic properties and economic effects, preferably of from 0.5 to 15 μm, more preferably from 1 to 10 μm, and most preferably from 1 to 5 μm.

The a-Si photoreceptor for use in the present invention can optionally include a surface layer on the photosensitive layer located on the substrate, which is preferably an a-Si surface layer. The surface layer has a free surface and is formed to attain objects of the present invention in humidity resistance, repeated use resistance, electric pressure resistance, environment resistance and durability of the photoreceptor.

The surface layer preferably has a thickness of from 0.01 to 3 μm, more preferably from 0.05 to 2 μm, and most preferably from 0.1 to 1 μm. When less than 0.01 μm, the surface layer is lost due to abrasion during use of the photoreceptor. When greater than 3 μm, deterioration of the electrophotographic properties occurs, such as an increase of residual potential of the photoreceptors.

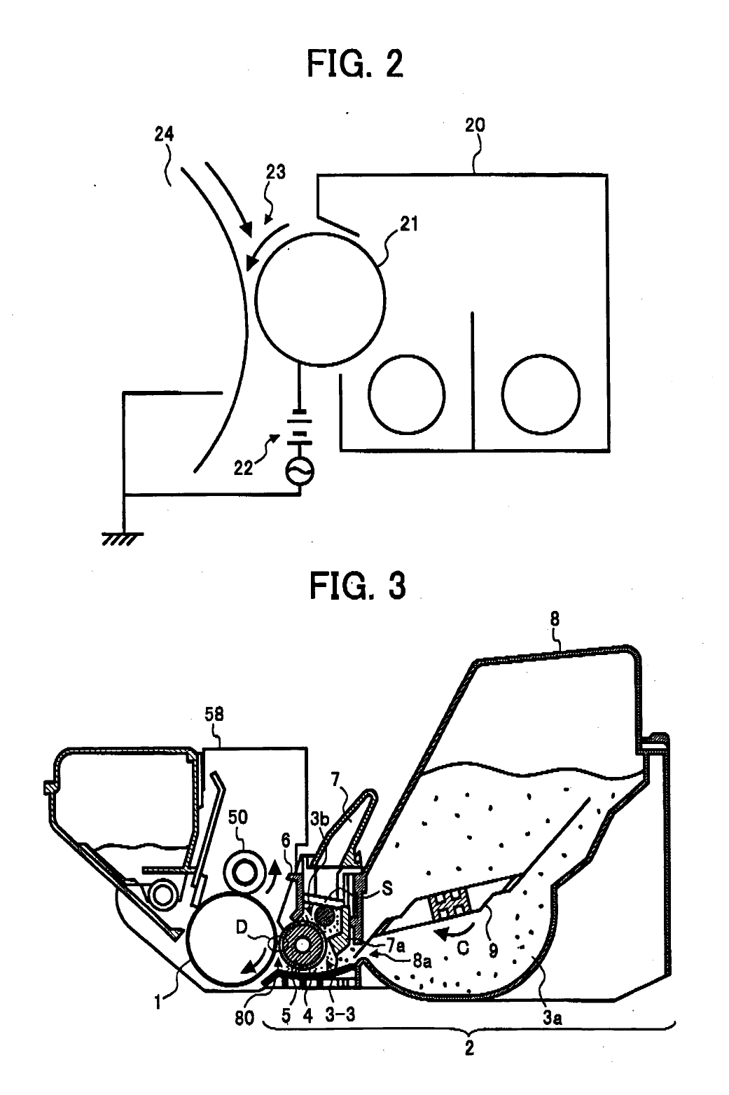

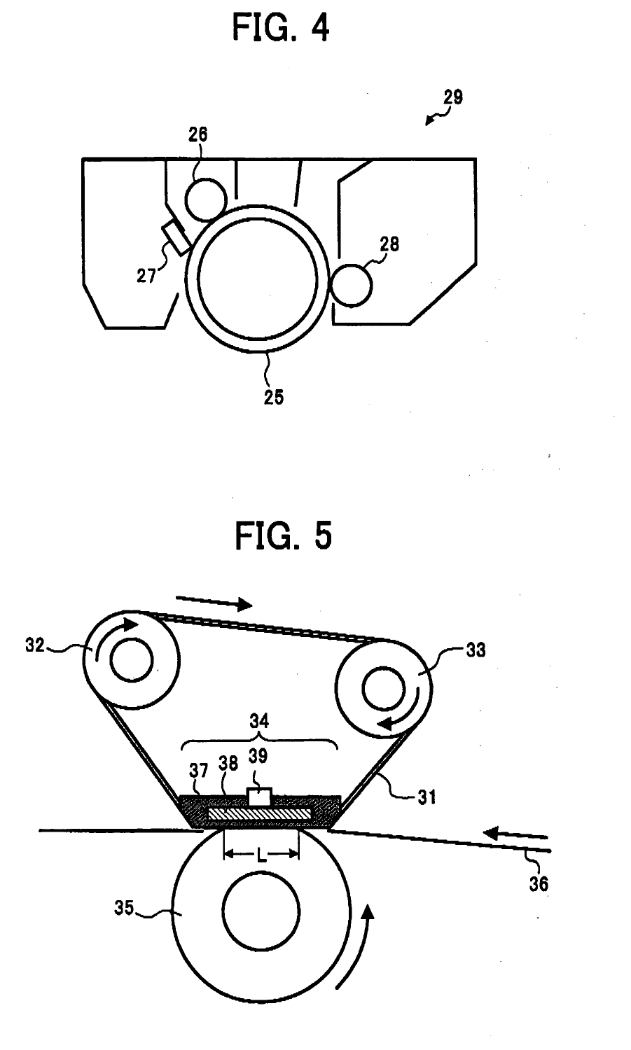

In an image developer (2) in FIG. 2, a vibration bias voltage, which is a DC voltage overlapped with an AC voltage, is applied to a developing sleeve (4) from an electric source (10) as a developing bias when developing an image. The background potential and image potential are located between a maximum and a minimum of the vibration bias potential. An alternating electric field, changing the direction alternately, is formed at a developing portion (D). In the alternating electric field, the toner and carrier intensely vibrate, and the toner flies to a photoreceptor drum (1), being released from an electrostatic binding force of the developing sleeve (4), and the carrier and toner are transferred to a latent image on the photoreceptor drum (1).

A difference between the maximum and minimum of the vibration bias voltage (voltage between the peaks) is preferably from 0.5 to 5 KV, and the frequency thereof is preferably from 1 to 10 KHz. The vibration bias voltage can have the waveform of a rectangular wave, a sine curve or a triangular wave. The DC voltage of the vibration bias is a value between the background potential and image potential as mentioned above, and is preferably closer to the background potential than to the image potential to prevent the toner from adhering to the background.

When the vibration bias voltage has the waveform of a rectangular wave, the duty ratio is preferably not greater than 50%. The duty ratio is a time ratio relating the time during which the toner is headed for the photoreceptor to one cycle of the vibration bias. A difference between the peak value and time average of the bias orienting the toner to the photoreceptor can be large, and therefore the toner moves more actively and faithfully adheres to the latent image to decrease roughness and improve image resolution of the toner image. In addition, the difference between the peak value and time average of the bias orienting the carrier to the photoreceptor can be small, and therefore the carrier becomes inactive and probability of the carrier adherence to the background of the latent image can largely be decreased.

FIG. 3 is a schematic view illustrating an embodiment of the process cartridge of the present invention.

In FIG. 3, numeral (31) is a whole process cartridge, (32) is a photoreceptor,
(33) is a charger, (34) is an image developer and (35) is a cleaner.

In an image forming apparatus using a process cartridge including the toner of the present invention, a photoreceptor rotates at a predetermined peripheral speed. A peripheral surface of the photoreceptor is positively or negatively charged uniformly by a charger while the photoreceptor is rotating to have a predetermined potential. Next, the photoreceptor receives an imagewise light from an irradiator, such as a slit irradiator and a laser beam scanner to form an electrostatic latent image on the peripheral surface thereof. Then, the electrostatic latent image is developed by an image developer with a toner to form a toner image. Next, the toner image is transferred onto a transfer material fed between the photoreceptor and a transferer from a paper feeder in synchronization with the rotation of the photoreceptor. Then, the transfer material which received the toner image is separated from the surface of the photoreceptor and led to an image fixer fixing the toner image on the transfer material to form a copy image which is discharged out of the apparatus. The surface of the photoreceptor is cleaned by a cleaner to remove a residual toner after transfer, and is discharged to repeat forming images.

The fixer is a surf fixer rotating a fixing film as shown in FIG. 5. The fixing film is a heat resistant film having the shape of an endless belt, which is suspended and strained among a driving roller, a driven roller and a heater located therebetween underneath.

The driven roller is a tension roller as well, and the fixing film rotates clockwise according to a clockwise rotation of the driving roller in FIG. 5. The rotational speed of the fixing film is equivalent to that of a transfer material at a fixing nip area L where a pressure roller and the fixing film contact each other.

The pressure roller has a rubber elastic layer having good releasability such as silicone rubbers, and rotates counterclockwise while contacting the fixing nip area L at a total pressure of from 4 to 10 kg.

The fixing film preferably has a good heat resistance, releasability and durability, and has a total thickness not greater than 100 μm, and preferably not greater than 40 μm. Specific examples of the fixing film include, but are not limited to, films formed of a single-layered or a multi-layered film of heat resistant resins such as polyimide, polyetherimide, polyethersulfide (PES) and a tetrafluoroethyleneperfluoroalkylvinylether copolymer resin (PFA) having a thickness of 20 μm, on which, contacting an image, is coated a release layer including a fluorocarbon resin such as a tetrafluoroethylene resin (PTFE) and a PFA and an electroconductive material and having a thickness of 10 μm or an elastic layer formed of a rubber such as a fluorocarbon rubber and a silicone rubber.

In FIG. 5, the heater is formed of a flat substrate and a fixing heater, and the flat substrate is formed of a material having a high heat conductivity and a high electric resistance such as alumina. The fixing heater formed of a resistance heater is located on a surface of the heater contacting the fixing film in the longitudinal direction of the heater. An electric resistant material such as Ag/Pd and Ta₂N is linearly or zonally coated on the fixing heater by a screen printing method, etc. Both ends of the fixing heater have electrodes (not shown) and the resistant heater generates heat when electricity passes though the electrodes. Further, a fixing temperature sensor formed of a thermistor is located on the side of the substrate opposite to the side on which the fixing heater is located.

Temperature information regarding the substrate, and detected by the fixing temperature sensor, is transmitted to a controller controlling electric energy provided to the fixing heater to make the heater have a predetermined temperature.

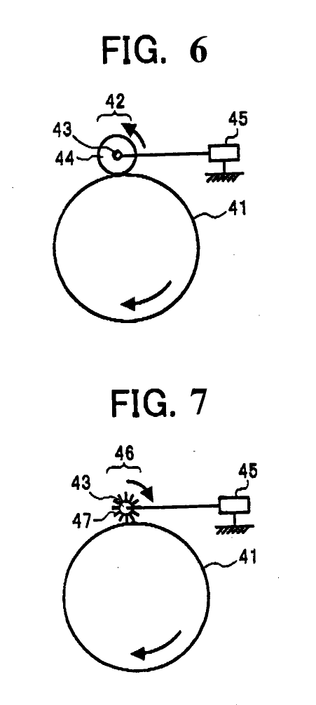

FIG. 6 is a schematic view illustrating an embodiment of the image forming apparatus using a contact charger of the present invention. A photoreceptor to be charged and an image bearer rotates at a predetermined speed (process speed) in the direction of the arrow. A roller-shaped charging roller as a charger contacting the photoreceptor is basically formed of a metallic shaft and an electroconductive rubber layer circumferentially and concentrically overlying the metallic shaft. Both ends of the metallic shaft are rotatably supported by a bearing (not shown), etc. and the charging roller is pressed against the photoreceptor by a pressurizer (not shown) at a predetermined pressure. In FIG. 6, the charging roller rotates according to the rotation of the photoreceptor. The charging roller has a preferred diameter of 16 mm because of being formed of a metallic shaft having a diameter of 9 mm and a middle-resistant rubber layer having a resistance of about 100,000 Ω·cm coated on the metallic shaft.

The shaft of the charging roller and an electric source are electrically connected with each other, and the electric source applies a predetermined bias to the charging roller. Accordingly, a peripheral surface of the photoreceptor is uniformly charged to have a predetermined polarity and a potential.

The charger for use in the present invention may have any form or shape besides the roller, such as magnetic brushes and fur brushes, and is selectable according to a specification or a form of the electrophotographic image forming apparatus. The magnetic brush is formed of various ferrite particles such as Zn-Cu ferrite as a charging member, a non-magnetic electroconductive sleeve supporting the charging member and a magnet roll included by the non-magnetic electroconductive sleeve. The fur brush is a charger formed of a shaft subjected to an electroconductive treatment and a fur subjected to an electroconductive treatment with, e.g., carbon, copper sulfide, metals and metal oxides winding around or adhering to the shaft.

FIG. 7 is a schematic view illustrating another embodiment of an image forming apparatus using a contact charger of the present invention. A photoreceptor to be charged and an image bearer rotates at a predetermined speed (process speed) in the direction of the arrow. A brush roller formed of a fur brush contacts a photoreceptor at a predetermined pressure against an elasticity of the brush and a nip width.

The fur brush roller in this embodiment is a roll brush preferably having an outer diameter of 14 mm and a longitudinal length of 250 mm, which is formed of a metallic shaft having a preferred diameter of 6 mm and being an electrode as well, and a pile fabric tape of an electroconductive rayon fiber REC-B® from Unitika Ltd. spirally winding around the shaft. The brush is preferably 300 denier/50 filament and has a density of 155 fibers/mm². The roll brush is inserted into a pipe preferably having an inner diameter of 12 mm while rotated in a direction such that the brush and pipe are concentrically located, and is left in an environment of high humidity and high temperature to have inclined furs.

The fur brush roller preferably has a resistance of 1×10⁵ Ω when the applied voltage is 100 V. The resistance is converted from a current when a voltage of 100 V is applied to the fur brush roller contacting a metallic drum having a preferred diameter of 30 mm at a nip width of 3 mm.

The resistance needs to be not less than 10⁴ Ω and not greater than 10⁷ Ω to prevent defect images due to an insufficiently charged nip when a large amount of leak current flows into a defect such as a pin hole on the photoreceptor, and to sufficiently charge the photoreceptor.

Besides the REC-B® from Unitika Ltd., specific examples of the brush material include REC-C®, REC-M1® and REC-M10® therefrom; SA-7® from Toray Industries, Inc.; Thunderon® from Nihon Sanmo Dyeing Co., Ltd.; Belltron® from Kanebo, Ltd.; Clacarbo® from Kuraray Co., Ltd.; carbon-dispersed rayon; and Roval® from MITSUBISHI RAYON CO., LTD. The brush preferably has a denier of from 3 to 10/fiber, a filament of from 10 to 100/batch and a density of from 80 to 600 fibers/mm². The fiber preferably has a length of from 1 to 10 mm.

The fur brush roller rotates in a direction counter to the rotation direction of the photoreceptor at a predetermined peripheral speed (surface speed) and contacts the surface of the photoreceptor at a different speed. A predetermined charging voltage is applied to the fur brush roller from an electric source to uniformly charge the surface of the photoreceptor to have a predetermined polarity and potential. In this embodiment, the fur brush roller contacts the photoreceptor to charge the photoreceptor, which is dominantly a direct injection charge, and the surface of the photoreceptor is charged to have a potential almost equal to an applied charging voltage to the fur brush roller.

The charger for use in the present invention may have any form or shape besides the fur brush roller, such as charging rollers and fur brushes, and is selectable according to a specification or a form of the electrophotographic image forming apparatus. The charging roller is typically formed of metallic shaft coated with a middle-resistant rubber layer having a preferred resistance of about 100,000 Ω·cm. The magnetic brush is formed of various ferrite particles such as Zn-Cu ferrite as a charging member, a non-magnetic electroconductive sleeve supporting the ferrite particles and a magnet roll included by the non-magnetic electroconductive sleeve.

FIG. 7 also is a schematic view illustrating another embodiment of the image forming apparatus using a contact charger of the present invention. A photoreceptor to be charged and an image bearer rotate at a predetermined speed (process speed) in the direction of the arrow. A brush roller formed of a magnetic brush contacts a photoreceptor at a predetermined pressure against an elasticity of the brush and a nip width.

The magnetic brush for use in the present invention as a contact charger includes magnetic particles coated with a middle-resistant resin including a mixture of Zn—Cu ferrite particles preferably having a bimodal average particle diameter of 25 and 10 μm and a mixing weight ratio (25 μm/10 μm) of 1/0.05. The contact charger is formed of the coated magnetic particles, a non-magnetic electroconductive sleeve supporting the magnetic particles and a magnet roll included by the non-magnetic electroconductive sleeve. The coated magnetic particles are coated on the sleeve at a coated thickness of preferably 1 mm to form a charging nip having a preferred width of about 5 mm between the sleeve and photoreceptor, and a gap therebetween is preferably about 500 μm. The magnet roll rotates in a direction counter to the rotation direction of the photoreceptor at a speed of twice as fast as a peripheral speed of a surface of the photoreceptor, such that a surface of the sleeve frictionizes the surface of the photoreceptor and the magnetic brush uniformly contacts the photoreceptor.

The charger for use in the present invention may have any form or shape besides the magnetic brush roller, such as charging rollers and fur brushes, and is selectable according to a specification or a form of the electrophotographic image forming apparatus. The charging roller is typically formed of a metallic shaft coated with a middle-resistant rubber layer having a preferred resistance of about 100,000 Ω·cm. The fur brush is a charger formed of a shaft subjected to an electroconductive treatment and a fur subjected to an electroconductive treatment with, e.g., carbon, copper sulfide, metals and metal oxides winding around or adhering to the shaft.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Synthesis of Toner Binder Resin

724 parts of an adduct of bisphenol A with 2 moles of ethyleneoxide, 276 parts isophthalic acid and 2 parts of dibutyltinoxide are mixed and reacted in a reactor vessel including a cooling pipe, a stirrer and a nitrogen inlet pipe for 8 hrs at normal pressure and 230° C. Further, after the mixture is depressurized to 10 to 15 mm Hg (absolute) and reacted for 5 hrs, 32 parts of phthalic acid anhydride are added thereto and reacted for 2 hrs at 160° C. Next, the mixture is reacted with 188 parts of isophoronediisocyanate in ethyl acetate for 2 hrs at 80° C. to prepare a prepolymer including isocyanate (1). Next, 67 parts of the prepolymer (1) and 14 parts of isophoronediamine are mixed for 2 hrs at 50° C. to prepare a urea-modified polyester resin (1) having a weight-average molecular weight of 64,000. Similarly, 724 parts of an adduct of bisphenol A with 2 moles of ethyleneoxide and 276 parts of terephthalic acid are polycondensed for 8 hrs at normal pressure and 230° C., and further, after the mixture is depressurized to 10 to 15 mm Hg (absolute) and reacted for 5 hrs to prepare a unmodified polyester resin (a) having a peak molecular weight of 5,000. 200 parts of the urea-modified polyester (1) and 800 parts of the unmodified polyester resin (a) are dissolved and mixed in 2,000 parts of a mixed solvent formed of ethyl acetate and MEK (1/1) to prepare a toner binder resin (1) ethyl acetate/MEK solution. The toner binder resin (1) ethyl acetate/MEK solution is partially depressurized and dried to isolate the toner binder resin (1). The toner binder resin (1) has a glass transition temperature (Tg) of 62° C. and an acid value of 10.

Preparation of Toner

240 parts of the toner binder resin (1) ethyl acetate/MEK solution, 20 parts of pentaerythritol tetrabehenate having a melting point of 81° C. and a melting viscosity of 25 cps and 10 parts of carbon black are mixed at 12,000 rpm in a beaker by a TK-type homomixer at 60° C. to uniformly dissolve and disperse the mixture to prepare a toner material solution. 706 parts of ion-exchanged water, 294 parts of a slurry including 10% hydroxyapatite Supertite 10 from Nippon Chemical Industrial Co., Ltd. and 0.2 parts of sodium dodecylbenzenesulfonate are uniformly dissolved in a beaker. Then, while the mixture is stirred at 12,000 rpm by a TK-type homomixer at 60° C., the above-mentioned toner material solution is added thereto and the mixture is stirred for 10 min. Next, the mixture is moved into a flask with a stirrer and a thermometer, and heated at 98° C. to partially remove solvent. Further, the mixture is stirred at 12,000 rpm by a TK-type homomixer at a room temperature to completely remove the solvent. Then, the mixture is filtered, washed, dried and classified by wind force to prepare a mother toner having a weight-average particle diameter (D4) of 6.35 μm, a number-average particle diameter (Dn) of 5.57 μm and D4/Dn of 1.14. Finally, 100 parts of the mother toner and 0.5 parts of hydrophobic silica are mixed by HENSCHEL mixer to prepare the toner of the present invention (1). The other detailed conditions and evaluations results are shown in Tables 1 to 3.

### Example 2

### Synthesis of Toner Binder Resin

Similarly to Example 1, after 334 parts of an adduct of bisphenol A with 2 moles of ethyleneoxide, 334 parts of an adduct of bisphenol A with 2 moles of propyleneoxide, 274 parts isophthalic acid and 20 parts of trimellitic acid anhydride are polycondensed, 154 parts of isophoronediisocyanate were reacted with the polycondensed material to prepare a prepolymer (2). Next, 213 parts of the prepolymer (2), 9.5 parts of isophoronediamine and 0.5 parts dibutylamine are reacted similarly to Example 1 to prepare a urea-modified polyester resin (2) having a weight-average molecular weight of 79,000. 200 parts of the urea-modified polyester (2) and 800 parts of the unmodified polyester resin (a) are dissolved and mixed in 2,000 parts of a mixed solvent formed of ethyl acetate and MEK (1/1) to prepare a toner binder resin (1) ethyl acetate/MEK solution. The toner binder resin (1) ethyl acetate/MEK solution is partially depressurized and dried to isolate the toner binder resin (2). The toner binder resin (1) has a peak molecular weight of 5,000, a glass transition temperature (Tg) of 62° C. and an acid value of 10.

Preparation of Toner

The procedure for preparation of the toner in Example 1 is repeated to prepare a mother toner (2) except for changing the toner binder resin (1) to the toner binder resin (2) and dissolution and dispersion temperature to 50° C. Further, 1.0 parts of a zinc salt of a salicylic acid derivative is mixed and stirred in a heating atmosphere with 100 parts of the mother toner (2) as a charge controlling agent to fix the charge controlling agent thereon. The mother toner (2) has a weight-average particle diameter (D4) of 5.64 μm, a number-average particle diameter (Dn) of 4.98 μm and D4/Dn of 1.13. Finally, 100 parts of the mother toner and 1.0 parts of hydrophobic silica and 0.5 parts of a hydrophobic titanium oxide are mixed by HENSCHEL mixer to prepare the toner of the present invention (2). The other detailed conditions and evaluations results are shown in Tables 1 to 3.

### Example 3

### Synthesis of Toner Binder Resin

30 parts of the urea-modified polyester resin (1) and 970 parts of the unmodified polyester resin (a) are dissolved and mixed in 2,000 parts of the mixed solvent formed of ethyl acetate and MEK (1/1) to prepare a toner binder resin (3) ethyl acetate/MEK solution. The toner binder resin (3) ethyl acetate/MEK solution is partially depressurized and dried to isolate the toner binder resin (3). The toner binder resin (1) has a peak molecular weight of 5,000, a glass transition temperature (Tg) of 62° C. and an acid value of 10.

Preparation of Toner

The procedure for preparation of the toner in Example 2 is repeated to prepare a toner (3) except for changing the toner binder resin (2) to the toner binder resin (3) and colorant to 8 parts of carbon black. The mother toner has a weight-average particle diameter (D4) of 6.72 μm, a number-average particle diameter (Dn) of 6.11 μm and D4/Dn of 1.10. The other detailed conditions and evaluations results are shown in Tables 1 to 3.

### Example 4

### Synthesis of Toner Binder Resin

500 parts of the urea-modified polyester resin (1) and 500 parts of the unmodified polyester resin (a) are dissolved and mixed in 2,000 parts of the mixed solvent formed of ethyl acetate and MEK (1/1) to prepare a toner binder resin (4) ethyl acetate/MEK solution. The toner binder resin (4) ethyl acetate/MEK solution is partially depressurized and dried to isolate the toner binder resin (4). The toner binder resin (4) has a peak molecular weight of 5,000, a glass transition temperature (Tg) of 62° C. and an acid value of 10.

Preparation of Toner

The procedure for preparation of the toner in Example 1 is repeated to prepare a toner (4) except for changing the toner binder resin (1) to the toner binder resin (4) and colorant to 8 parts of carbon black. The mother toner has a weight-average particle diameter (D4) of 4.98 μm, a number-average particle diameter (Dn) of 4.35 μm and D4/Dn of 1.14. The other detailed conditions and evaluations results are shown in Tables 1 to 3.

### Example 5

### Synthesis of Toner Binder Resin

750 parts of the urea-modified polyester resin (1) and 250 parts of the unmodified polyester resin (a) are dissolved and mixed in 2,000 parts of the mixed solvent formed of ethyl acetate and MEK (1/1) to prepare a toner binder resin (5) ethyl acetate/MEK solution. The toner binder resin (5) ethyl acetate/MEK solution is partially depressurized and dried to isolate the toner binder resin (5). The toner binder resin (5) has a peak molecular weight of 5,000, a glass transition temperature (Tg) of 62° C. and an acid value of 10.

Preparation of Toner

The procedure for preparation of the toner in Example 1 is repeated to prepare a toner (5) except for changing the toner binder resin (1) to the toner binder resin (5). The mother toner has a weight-average particle diameter (D4) of 5.93 μm, a number-average particle diameter (Dn) of 5.25 μm and D4/Dn of 1.14. The other detailed conditions and evaluations results are shown in Tables 1 to 3.

### Example 6

### Synthesis of Toner Binder Resin

850 parts of the urea-modified polyester resin (1) and 150 parts of the unmodified polyester resin (a) are dissolved and mixed in 2,000 parts of the mixed solvent formed of ethyl acetate and MEK (1/1) to prepare a toner binder resin (6) ethyl acetate/MEK solution. The toner binder resin (6) ethyl acetate/MEK solution is partially depressurized and dried to isolate the toner binder resin (6). The toner binder resin (6) has a peak molecular weight of 5,000, a glass transition temperature (Tg) of 62° C. and an acid value of 10.

Preparation of Toner

The procedure for preparation of the toner in Example 1 is repeated to prepare a toner (6) except for changing the toner binder resin (1) to the toner binder resin (6). The mother toner has a weight-average particle diameter (D4) of 3.90 μm, a number-average particle diameter (Dn) of 3.38 μm and D4/Dn of 1.15. The other detailed conditions and evaluations results are shown in Tables 1 to 3.

### Example 7

### Synthesis of Toner Binder Resin

724 parts of an adduct of bisphenol A with 2 moles of ethyleneoxide, 276 parts terephthalic acid are polycondensed for 2 hrs at normal pressure and 230° C. Further, the mixture is depressurized to 10 to 15 mm Hg (absolute) and reacted for 5 hrs to prepare an unmodified polyester resin (b) having a peak molecular weight of 800. 200 parts of the urea-modified polyester resin (1) and 800 parts of the unmodified polyester resin (b) are dissolved and mixed in 2,000 parts of the mixed solvent formed of ethyl acetate and MEK (1/1) to prepare a toner binder resin (7) ethyl acetate/MEK solution. The toner binder resin (7) ethyl acetate/MEK solution is partially depressurized and dried to isolate the toner binder resin (7). The toner binder resin (7) has a glass transition temperature (Tg) of 45° C.

Preparation of Toner

The procedure for preparation of the toner in Example 1 is repeated to prepare a toner (7) except for changing the toner binder resin (1) to the toner binder resin (7). The mother toner has a weight-average particle diameter (D4) of 5.22 μm, a number-average particle diameter (Dn) of 4.50 μm and D4/Dn of 1.16. The other detailed conditions and evaluations results are shown in Tables 1 to 3.

### Example 8

210 parts of the toner binder solution prepared in Example 1 were diluted with 210 parts of ethyl acetate, and 210 parts of the diluted dispersion are emulsified and granulated similarly to Example 1. Then, the procedure for preparation of the toner in Example 1 is repeated to prepare a toner 8. The mother toner has a weight-average particle diameter (D4) of 4.25 μm, a number-average particle diameter (Dn) of 3.73 μm and D4/Dn of 1.14. The other detailed conditions and evaluations results are shown in Tables 1 to 3.

### Example 9

350 parts of the toner constituents, after being dispersed with the homomixer to remove the solvent of Example 1 therefrom, are condensed to 175 parts with an evaporator, and 210 parts of the condensed dispersion are emulsified and granulated similarly to Example 1. Then, the procedure for preparation of the toner in Example 1 is repeated to prepare a toner 9. The mother toner has a weight-average particle diameter (D4) of 6.95 μm, a number-average particle diameter (Dn) of 5.65 μm and D4/Dn of 1.23. The other detailed conditions and evaluations results are shown in Tables 1 to 3.

### Example 10

210 parts of the toner constituents, after being dispersed with the homomixer to remove the solvent of Example 1 therefrom, are diluted with 965 parts of ethyl acetate, and 210 parts of the diluted dispersion are emulsified and granulated similarly to Example 1. Then, the procedure for preparation of the toner in Example 1 is repeated to prepare a toner 10. The mother toner has a weight-average particle diameter (D4) of 3.95 μm, a number-average particle diameter (Dn) of 3.43 μm and D4/Dn of 1.15. The other detailed conditions and evaluations results are shown in Tables 1 to 3.

### Example 11

350 parts of the toner constituents, after being dispersed with the homomixer to remove the solvent of Example 1 therefrom, are condensed to 125 parts with an evaporator, and 210 parts of the condensed dispersion are emulsified and granulated similarly to Example 1. Then, the procedure for preparation of the toner in Example 1 is repeated to prepare a toner 11. The mother toner has a weight-average particle diameter (D4) of 6.84 μm, a number-average particle diameter (Dn) of 5.61 μm and D4/Dn of 1.22. The other detailed conditions and evaluations results are shown in Tables 1 to 3.

### Comparative Example 1

### Synthesis of Toner Binder Resin

354 parts of an adduct of bisphenol A with 2 moles of ethyleneoxide and 166 parts of isophthalic acid are polycondensed with 2 parts of dibutyltinoxide as a catalyst to prepare a comparative toner binder resin (1) having a peak molecular weight of 4,000. The comparative toner binder resin (1) has a glass transition temperature (Tg) of 57° C.

Preparation of Toner

100 parts of the comparative toner binder resin (1), 200 parts of ethyl acetate solution and 10 parts carbon black are mixed at 12,000 rpm in a beaker by a TK-type homomixer at 50° C. to uniformly dissolve and disperse the mixture. Then, the procedure for preparation of the toner in Example 1 is repeated to prepare a comparative toner (1). The mother toner has a weight-average particle diameter (D4) of 7.51 μm, a number-average particle diameter (Dn) of 6.05 μm and D4/Dn of 1.24. The other detailed conditions and evaluations results are shown in Tables 1 to 3.

### Comparative Example 2

343 parts of an adduct of bisphenol A with 2 moles of ethyleneoxide, 166 parts isophthalic acid and 2 parts of dibutyltinoxide are mixed and reacted in a reactor vessel including a cooling pipe, a stirrer and a nitrogen inlet pipe for 8 hrs at a normal pressure and 230° C. Further, after the mixture is depressurized by 10 to 15 mm Hg (absolute) and reacted for 5 hrs, the mixture is cooled to 80° C. Next, the mixture is reacted with 14 parts of toluenediisocyanate in toluene for 5 hrs at 150° C., and then solvent is removed therefrom to prepare a urethane-modified polyester resin having a weight-average molecular weight of 98,000. 363 parts of an adduct of bisphenol A with 2 moles of ethyleneoxide and 166 parts of isophthalic acid are polycondensed similarly to Example 1 to prepare a unmodified polyester resin having a peak molecular weight of 3,800 and an acid value of 7. 350 parts of the urethane-modified polyester and 650 parts of the unmodified polyester resin are dissolved and mixed in toluene, and a solvent is removed from the mixture to prepare a comparative toner binder resin (2). The toner binder resin (2) has a glass transition temperature (Tg) of 58° C.

Preparation of Toner

100 parts of the comparative toner binder resin (2) and 8 parts of carbon black are preliminarily mixed by a HENSCHEL mixer and kneaded by a continuous kneader. Then, the kneaded mixture is pulverized by a jet pulverizer and classified by a wind classifier to prepare a mother toner. 100 parts of the mother toner and 1.0 parts of hydrophobic silica and 0.5 parts of a hydrophobic titanium oxide are mixed by HENSCHEL mixer to prepare a comparative toner (2). The mother toner has a weight-average particle diameter (D4) of 6.50 μm, a number-average particle diameter (Dn) of 5.50 μm and D4/Dn of 1.18. The other detailed conditions and evaluations results are shown in Tables 1 to 3.

### Comparative Example 3

### Synthesis of Toner Binder Resin

354 parts of an adduct of bisphenol A with 2 moles of ethyleneoxide and 166 parts of terephthalic acid are polycondensed with 2 parts of dibutyltinoxide as a catalyst to prepare a comparative toner binder resin (3) having a peak molecular weight of 12,000. The comparative toner binder resin (3) has a glass transition temperature (Tg) of 62° C. and an acid value of 10.

Preparation of Toner

100 parts of the comparative toner binder resin (3), 200 parts of ethyl acetate solution and 4 parts of copper phthalocyanine pigment are mixed at 12,000 rpm in a beaker by a TK-type homomixer at 50° C. to uniformly dissolve and disperse the mixture. Then, the procedure for preparation of the toner in Example 5 is repeated to prepare a comparative toner (3). The mother toner has a weight-average particle diameter (D4) of 6.12 μm, a number-average particle diameter (Dn) of 4.64 μm and D4/Dn of 1.32. The other detailed conditions and evaluations results are shown in Tables 1 to 3.

### Comparative Example 4

The procedure for preparation of the toner in Example 1 is repeated to prepare a comparative example toner (4) except for stirring at 18,000 rpm with the homomixer to completely remove the solvent. The other detailed conditions and evaluations results are shown in Tables 1 to 3.

### Comparative Example 5

The procedure for preparation of the toner in Example 1 is repeated to prepare a comparative example toner (5) except for mixing 0.2 parts of hydrophobic silica having a primary particle diameter of 35 μm with the HENSCHEL mixer with 100 parts of the mother toner. The other detailed conditions and evaluations results are shown in Tables 1 to 3.

### Comparative Example 6

The procedure for preparation of the toner in Example 1 is repeated to prepare a comparative example toner (6) except for mixing 0.2 parts of the hydrophobic silica with the HENSCHEL mixer with 100 parts of the mother toner. The other detailed conditions and evaluations results are shown in Tables 1 to 3.

### Comparative Example 7

The procedure for preparation of the toner in Example 1 is repeated to prepare a comparative example toner (7) except for mixing 5.8 parts of the hydrophobic silica with the HENSCHEL mixer with 100 parts of the mother toner. The other detailed conditions and evaluations results are shown in Tables 1 to 3.

The volume-average particle diameter (D4) and number-average particle diameter (Dn) of the toner were measured by a Coulter Counter TA-II connected with an interface producing a number distribution and a volume distribution from Nikkaki Bios Co., Ltd. and a personal computer PC9801 from NEC Corp. using a NaCl aqueous solution including an elemental sodium content of 1% as an electrolyte as follows:
0.1 to 5 ml of a detergent, preferably alkylbenzene sulfonate is included as a dispersant in 100 to 150 ml of the electrolyte;
2 to 20 mg of a sample toner is included in the electrolyte and the toner is dispersed by an ultrasonic disperser for about 1 to 3 min to prepare a sample dispersion liquid;
the sample dispersion liquid is included in 100 to 200 ml of the electrolyte in another beaker so as to have a predetermined concentration;
a particle diameter distribution of the particles having a number-average particle diameter of from 2 to 40 μm is measured by the Coulter Counter TA-II using an aperture of 100 μm to determine volume and number distribution thereof; and
a weight-average particle diameter (D4) based on the volume distribution is determined.

A peripheral length of a circle having an area equivalent to that of a projected image optically detected is divided by an actual peripheral length of the toner particle to determine the circularity of the toner. Specifically, the circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

The SF-1 was be measured by randomly sampling toner images enlarged 1,000 times relative to the original images, which have about 100 particles (or more), using a scanning electron microscope S-800 from Hitachi, Ltd.; and introducing the image information to an image analyzer Luzex III from NIRECO Corp. through an interface to analyze the information.

The image density and was measured by X-Rite 938, and the background density was also measured thereby to evaluate background fouling.

Whether toner filming over the surface of a developing roller occurred was visually observed.
o: not occurred

x: occurred

TABLE 1

Shape

| | Particle diameter | | | Average | |
|---|---|---|---|---|---|
| | D4 | Dn | D4/Dn | circularity | SF-1 |
| Ex. 1 | 6.35 | 5.57 | 1.14 | 0.959 | 139 |
| Ex. 2 | 5.64 | 4.98 | 1.13 | 0.980 | 115 |
| Ex. 3 | 6.72 | 6.11 | 1.10 | 0.966 | 133 |
| Ex. 4 | 4.98 | 4.35 | 1.14 | 0.976 | 125 |
| Ex. 5 | 5.93 | 5.25 | 1.13 | 0.939 | 162 |
| Ex. 6 | 3.90 | 3.38 | 1.15 | 0.987 | 108 |
| Ex. 7 | 5.22 | 4.50 | 1.16 | 0.974 | 120 |
| Ex. 8 | 4.25 | 3.73 | 1.14 | 0.935 | 165 |
| Ex. 9 | 6.95 | 5.65 | 1.23 | 0.978 | 116 |
| Ex. 10 | 3.95 | 3.43 | 1.15 | 0.935 | 166 |
| Ex. 11 | 6.84 | 5.61 | 1.22 | 0.982 | 111 |
| Com. Ex. 1 | 7.51 | 6.05 | 1.24 | 0.955 | 144 |
| Com. Ex. 2 | 6.50 | 5.50 | 1.18 | 0.924 | 173 |
| Com. Ex. 3 | 6.12 | 4.64 | 1.32 | 0.960 | 128 |
| Com. Ex. 4 | 5.66 | 4.67 | 1.21 | 0.932 | 165 |
| Com. Ex. 5 | 6.75 | 5.57 | 1.21 | 0.948 | 142 |
| Com. Ex. 6 | 6.35 | 5.57 | 1.14 | 0.959 | 139 |
| Com. Ex. 7 | 6.35 | 5.57 | 1.14 | 0.959 | 139 |

TABLE 2

| | External additive 1 | | | | External additive 2 | | | |
|---|---|---|---|---|---|---|---|---|
| | | Primary | Secondary | Content | | Primary | Secondary | Content |
| | | particle | particle | (parts | | particle | particle | (parts |
| | | diameter | diameter | by | | diameter | diameter | by |
| | | (nm) | (nm) | weight) | | (nm) | (nm) | weight) |
| Ex. 1 | Hydrophobic | 10 | 120 | 0.5 | — | — | — | — |
| | silica | | | | | | | |
| Ex. 2 | Hydrophobic | 10 | 120 | 1.0 | Titanium | 15 | 150 | 0.5 |
| | silica | | | | oxide | | | |
| Ex. 3 | Hydrophobic | 10 | 120 | 1.5 | Titanium | 15 | 150 | 0.5 |
| | silica | | | | oxide | | | |
| Ex. 4 | Hydrophobic | 15 | 80 | 2.0 | — | — | — | — |
| | silica | | | | | | | |
| Ex. 5 | Hydrophobic | 15 | 80 | 2.5 | Titanium | 15 | 150 | 0.5 |
| | silica | | | | oxide | | | |
| Ex. 6 | Hydrophobic | 15 | 80 | 5.0 | — | — | — | — |
| | silica | | | | | | | |
| Ex. 7 | Titanium | 15 | 150 | 1.0 | — | — | — | — |
| | oxide | | | | | | | |
| Ex. 8 | Hydrophobic | 10 | 150 | 0.5 | — | — | — | — |
| | silica | | | | | | | |
| Ex. 9 | Hydrophobic | 10 | 150 | 0.5 | — | — | — | — |
| | silica | | | | | | | |
| Ex. | Hydrophobic | 10 | 150 | 0.5 | — | — | — | — |
| 10 | silica | | | | | | | |
| Ex. | Hydrophobic | 10 | 150 | 0.5 | — | — | — | — |
| 11 | silica | | | | | | | |
| Com. | Hydrophobic | 10 | 120 | 0.5 | — | — | — | — |
| Ex. 1 | silica | | | | | | | |
| Com. | Hydrophobic | 10 | 120 | 1.0 | Titanium | 15 | 150 | 0.5 |
| Ex. 2 | silica | | | | oxide | | | |
| Com. | Hydrophobic | 10 | 120 | 1.0 | Titanium | 15 | 150 | 0.5 |
| Ex. 3 | silica | | | | oxide | | | |
| Com. | Hydrophobic | 10 | 120 | 0.5 | — | — | — | — |
| Ex. 4 | silica | | | | | | | |
| Com. | Hydrophobic | 35 | — | 0.2 | — | — | — | — |
| Ex. 5 | silica | | | | | | | |
| Com. | Hydrophobic | 10 | 120 | 0.2 | — | — | — | — |
| Ex. 6 | silica | | | | | | | |
| Com. | Hydrophobic | 10 | 120 | 5.8 | — | — | — | — |
| Ex. 7 | silica | | | | | | | |

TABLE 3

| | | | Background | | | |
|---|---|---|---|---|---|---|
| | Image density | | fouling | | Filming | |
| | | After | | After | After | |
| | | 100,000 | | 100,000 | 100,000 | |
| | | images | | images | images | |
| | | were | | were | were | |
| | Initial | produced | Initial | produced | produced | Overall |
| Ex. 1 | 1.44 | 1.36 | 0.02 | 0.05 | ◯ | ◯ |
| Ex. 2 | 1.37 | 1.38 | 0.01 | 0.00 | ◯ | ◯ |
| Ex. 3 | 1.45 | 1.41 | 0.00 | 0.01 | ◯ | ◯ |
| Ex. 4 | 1.45 | 1.43 | 0.01 | 0.01 | ◯ | ◯ |
| Ex. 5 | 1.42 | 1.46 | 0.00 | 0.01 | ◯ | ◯ |
| Ex. 6 | 1.48 | 1.46 | 0.01 | 0.00 | ◯ | ◯ |
| Ex. 7 | 1.46 | 1.45 | 0.00 | 0.00 | ◯ | ◯ |
| Ex. 8 | 1.42 | 1.38 | 0.02 | 0.05 | ◯ | ◯ |
| Ex. 9 | 1.43 | 1.38 | 0.02 | 0.02 | ◯ | ◯ |
| Ex. 10 | 1.41 | 1.36 | 0.01 | 0.04 | ◯ | ◯ |
| Ex. 11 | 1.43 | 1.37 | 0.01 | 0.02 | ◯ | ◯ |
| Com. Ex. 1 | 1.44 | 1.40 | 0.04 | 0.54 | ◯ | X |
| Com. Ex. 2 | 1.36 | 1.31 | 0.02 | 0.16 | X | X |
| Com. Ex. 3 | 1.41 | 1.05 | 0.02 | 0.45 | X | X |
| Com. Ex. 4 | 1.31 | 1.01 | 0.03 | 0.55 | X | X |
| Com. Ex. 5 | 1.32 | 1.25 | 0.03 | 0.26 | X | X |
| Com. Ex. 6 | 1.09 | 0.82 | 0.04 | 0.05 | ◯ | X |
| Com. Ex. 7 | 1.39 | 1.42 | 0.05 | 0.58 | X | X |

This application claims priority and contains subject matter related to Japanese Patent Applications Nos. 2003-349060 and 2003-400263, filed on Oct. 8, 2003 and Nov. 28, 2003, respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

1. A toner comprising:
a particulate toner material having an average circularity of from 0.93 to 0.99; and
an external additive in an amount of from 0.3 to 5.0 parts by weight per 100 parts by weight of the particulate toner material,
wherein the particulate toner material comprises:
a modified polyester binder resin (i); and
a colorant;
wherein the toner has a melting viscosity of from 70 to 140 Pa·s at 160° C.,
a weight-average particle diameter (D4) of from 3 to 7 μm,
a ratio (D4/Dn) of the weight-average particle diameter to a number-average particle diameter (Dn) of the toner of from 1.01 to 1.25, and
wherein particles of the particulate toner material satisfy at least one of the following conditions (I) and (II): (I) particles having a particle diameter not greater than 4 μm are present in an amount less than 10% by number; or (II) particles having a particle diameter not less than 8 μm are present in an amount less than 2% by volume.

2. The toner of claim 1, wherein the toner has a shape factor (SF-1) of from 105 to 170.

3. The toner of claim 1, wherein the modified polyester binder resin (i) is a urea-modified polyester resin.

4. The toner of claim 1, wherein the external additive is at least one member selected from the group consisting of inorganic particulate materials and particulate polymer materials.

5. The toner of claim 1, wherein the external additive is a hydrophobized silica.

6. The toner of claim 1, wherein the toner is prepared by a method comprising:
dissolving or dispersing toner constituents including a prepolymer in an organic solvent to prepare a solution or dispersion; and
dispersing the solution or dispersion in an aqueous medium to prepare the modified polyester binder resin (i).

7. The toner of claim 1, wherein the particulate toner material further comprises an unmodified polyester binder resin (LL), and wherein a weight ratio (i/LL) of the modified polyester binder resin (i) to the unmodified polyester binder resin (LL) is from 5/95 to 80/20.

8. The toner of claim 7, wherein the unmodified polyester binder resin (LL) has a peak molecular weight of from 1,000 to 20,000.

9. The toner of claim 7, wherein the unmodified polyester binder resin (LL) has an acid value of from 10 to 30 mg KOH/g.

10. The toner of claim 7, wherein the unmodified polyester binder resin (LL) has a glass transition temperature (Tg) of from 35 to 55° C.

11. The toner of claim 1, further comprising a wax, wherein the wax is finely dispersed in the particulate toner material, and wherein a concentration of the wax at a surface of the particulate toner material is larger than a concentration thereof in a center of the particulate toner material.

12. The toner of claim 1, further comprising a charge controlling agent, wherein the charge controlling agent is fixed on at least a portion of a surface of the particulate toner material.

13. The toner of claim 1, wherein the toner is prepared by a volume contraction of from 10 to 90% in an aqueous medium using a solid dispersant.

14. The toner of claim 1, wherein the toner is prepared by a method comprising:
dispersing a micro-droplet particulate material comprising at least an organic solvent, a binder resin and a colorant in an aqueous medium including a particulate resin; and
removing the organic solvent.

15. The toner of claim 1, wherein the external additive has a primary particle diameter of from 5 to 20 nm and a secondary particle diameter of from 50 to 200 nm.

16. A cartridge comprising a containing and having therein the toner according to claim 1.

17. A two-component developer comprising the toner according to claim 1 and a carrier.

18. An image forming method comprising:
charging an electrophotographic photoreceptor to form an electrostatic latent image thereon;
developing the electrostatic latent image with a developer comprising the toner according to claim 1 to form a toner image thereon;
transferring the toner image onto a transfer sheet; and
fixing the toner image on the transfer sheet.
cleaning the electrophotographic photoreceptor to remove the developer remaining thereon.

19. An image forming apparatus comprising:
a charger configured to charge an electrophotographic photoreceptor to form an electrostatic latent image thereon;
an image developer configured to develop the electrostatic latent image with a developer comprising the toner according to claim 1 to form a toner image thereon;
a transferer configured to transfer the toner image onto a transfer sheet;
a fixer configured to fix the toner image on the transfer sheet; and
a cleaner configured to clean the electrophotographic photoreceptor to remove the developer remaining thereon.

20. The image forming apparatus of claim 19, wherein the electrophotographic photoreceptor is an amorphous silicon photoreceptor.

21. The image forming apparatus of claim 19, wherein the image developer applies an alternating current to the electrophotographic photoreceptor.

22. The image forming apparatus of claim 19, wherein the fixer comprises:
a heater;
a film contacting the heater; and
a pressurizer,
wherein the toner image is fixed on the transfer sheet between the film and the pressurizer upon application of heat.

23. The image forming apparatus of claim 19, wherein the charger charges the electrophotographic photoreceptor while contacting the electrophotographic photoreceptor.

24. A process cartridge detachable with an image forming apparatus, comprising:
an image developer configured to develop an electrostatic latent image with a developer comprising the toner according to claim 1; and
at least one of an electrophotographic photoreceptor, a charger and a cleaner.
